(19) United States
(12) Patent Application Publication
(10) Pub. No.: US 2008/0163549 A1
(43) Pub. Date: Jul. 10, 2008

(54) Sliding Window Assebly Having Security Pane Unit

(76) Inventor: Soon Seok Kim, Gyeonggi-do (KR)

Correspondence Address: INTELLECTUAL PROPERTY / TECHNOLOGY LAW, PO BOX 14329, RESEARCH TRIANGLE PARK, NC, 27709, US

(21) Appl. No.: 11/816,615

(22) PCT Filed: Feb. 28, 2006
(86) PCT No.: PCT/KR2006/000689

§ 371 Date: Aug. 17, 2007

(30) Foreign Application Priority Data
Mar. 3, 2005 (KR) 20-2005-0005663
Jan. 26, 2006 (KR) 20-2006-0002485

(51) Int. Cl. E05D 15/20; E06B 5/11

(52) U.S. Cl. 49/129

(57) ABSTRACT

Disclosed herein is a sliding window assembly having a security pane unit. The sliding window assembly includes a casing, a first security pane part, and a second security pane part. The casing has two or more rails and is open at a front thereof to an outside. The first security pane part has lattice strips, and slide grooves are formed on upper and lower portions of the first security pane part such that the first security pane part slides along an outer rail of the casing. The second security pane part has lattice strips, and is mounted to the same rail as the first security pane part at a central position of the casing in such a way as to be rotated via a rotary member. The secondary security pane part rotates about the rotary member to overlap the first security pane part and thus move leftwards and rightwards.

### TECHNICAL FIELD

The present invention relates, in general, to a sliding window assembly having a security pane unit and, more particularly, to a sliding window assembly having a security pane unit, which effectively prevents crime, may be opened or closed when necessary, realizes easy manufacture, installation, and repair, and has a sturdy structure, in addition to having a good appearance.

### BACKGROUND ART

A security pane unit is mounted to a window so as to protect property and life from residential break-ins, such as robberies or burglaries, and prevent children from carelessly falling from a multistoried building.

Conventional security pane units are typically classified into fixed-type security pane units and sliding-type security pane units. The fixed-type security pane unit is constructed so that a metal product formed through extrusion is assembled through welding or a similar process and is then fixed to a window frame or an outer wall. The sliding-type security pane unit is called an accordion window.

Since the fixed-type security pane unit is fixed to a window frame or an outer wall through welding, or is fixed thereto by forming a hole in the window frame or the outer wall and inserting an anchor into the hole, it is difficult to install the fixed-type security pane unit. Further, the fixed-type security pane unit closes an emergency exit in the event of emergencies, such as fires, so that the loss of lives may occur. Furthermore, when moving, it is impossible to remove furniture.

Meanwhile, referring to FIG. 1, a conventional sliding-type security pane unit 5 is installed between an upper frame 1 and a lower frame 2, and is moved while being foldable in a horizontal direction, thus being opened or closed when necessary. Thus, the sliding-type security pane unit overcomes the drawbacks of the fixed-type security pane unit. However, the sliding-type security pane unit is problematic in that it is difficult to manufacture the sliding-type security pane unit, and the material for the sliding-type security pane unit is expensive, so that the sliding-type security pane unit is also expensive. Further, when the sliding-type security pane unit is folded, large metallic sounds may be generated. Furthermore, the shape of the sliding-type security pane unit is simple, therefore the appearance of a window is poor.

A security window structure is proposed in Korean U.M. Registration No. 0272016. According to the cited document, the security window structure includes a sliding window, a security pane unit, an auxiliary bar, and a security-pane support hinge. The sliding window includes outer and inner panes, which are assembled within a window frame in such a way as to slide in a horizontal direction. The security pane unit is installed in the window frame in such a way as to be successively aligned with the outer pane in a row, with a locking unit provided on one end of the security pane unit. The auxiliary bar is secured to the window frame. The security-pane support hinge includes a rotary wing secured to the other end of the security pane unit, and a fixed wing secured to the outer pane. Thereby, when the security pane unit and the outer pane are arranged side by side, the security window structure is located at a locked position in which it is impossible to open the security window structure because of the outer pane and the security pane unit.

The security pane unit may be opened or closed when necessary, and may be installed in an existing window frame. However, the conventional security window structure is constructed so that the security pane unit is additionally mounted to an existing window. Thus, the conventional security window structure has the following problems, so that, even though it was developed long ago, is not used in practice.

First, the security pane unit is mounted only to one side of the window structure. Thus, when glass of the outer pane is broken, a person may break into a building through the window structure. Hence, the function of preventing crime is insufficient.

Second, when the security pane unit is installed in the existing window frame, it is installed beyond the outermost rail. In order to rotate the security pane unit, upper and lower ends of the security pane unit must have clearance of 10 mm or higher relative to the outermost rail of the window frame. In such a construction, it is possible to remove the security pane unit by raising the lower ends of the security pane unit and the outer pane with a simple tool, such as a screwdriver. Thus, the crime-prevention function of the conventional security window structure is poor.

Third, due to the weight difference between the security pane unit and the outer pane, the heavy security pane unit may sag, and the outer pane combined with the security pane unit may be lifted up toward the upper end of the window frame, so that the sliding motion of the outer pane is not easily performed.

Fourth, in order to install the security pane unit in an existing window frame, an insect screen must be removed, so that the conventional security window structure does not protect people against insects.

### DISCLOSURE OF INVENTION

### Technical Problem

Accordingly, the present invention has been made keeping in mind the above problems occurring in the prior art, and an object of the present invention is to provide a sliding window assembly having a security pane unit, which may be opened or closed when necessary, is manufactured at low cost, makes little noise during an opening or closing operation, and has various shapes, in addition to having a good appearance.

Another object of the present invention is to provide a sliding window assembly having a security pane unit, which has an excellent crime prevention function, requires a minimum of installation space, and affords easy manufacture, installation, and repair.

A further object of the present invention is to provide a sliding window assembly having a security pane unit, which is firm and may provide a function of protecting people against insects.

### Technical Solution

In order to accomplish the objects, the present invention provides a sliding window assembly having a security pane unit, including a casing which has two or more rails and is open at a front thereof to an outside, a first security pane part which has lattice strips, slide grooves being formed on upper and lower portions of the first security pane part such that the first security pane part slides along an outer rail of the casing, and a second security pane part which has lattice strips and is mounted to the same rail as the first security pane part at a central position of the casing in such a way as to be rotated via a rotary member, the secondary security pane part rotating about the rotary member to overlap the first security pane part and thus move leftwards and rightwards.

Such a construction is advantageous in that the window assembly may be opened or closed when necessary, so that people can escape through the window assembly in the event of an emergency, packages may be moved through the window assembly in the event of a move, the manufacture and installation of the window assembly are easy, and the manufacturing cost thereof is low. Further, the sliding window assembly of this invention is not foldable, so that little noise is made when the window assembly is opened or closed, and the window may have various lattice shapes, thus improving the appearance of a window.

Preferably, the second security pane part comprises a frame having a step, the step being provided on each of upper and lower portions of the second security pane part frame, and formed to be lower at an inside position thereof.

Glass may be further provided on one side of the first security pane part, and an inner pane part having glass may be provided inside the second security pane part. Further, an insect screen may be further installed on one side of the second security pane part.

Such a construction is advantageous in that it can provide a security pane unit functioning as a glass door for a veranda.

The sliding window assembly may further include a support means to maintain the first and second security pane parts in an overlapping state. Preferably, the support means comprises a magnet provided in at least one of the first and second security pane parts. Such a construction advantageously prevents the first and second security pane parts from being separated from each other when the first and second security pane parts overlap each other and move in a horizontal direction.

In order to accomplish the objects, the present invention provides a sliding window assembly having a security pane unit, including a casing which has two or more rails and is open at a front thereof to an outside, a glass security pane part which includes a glass security pane frame having at each of upper and lower portions thereof a slide groove such that the glass security pane part slides along an outer rail of the casing, glass being provided to a first side of the glass security pane frame, and a security pane being secured to a second side of the glass security pane frame via a presser, and a security pane part which is mounted to the same rail as the glass security pane part via a rotary member and rotates about the rotary member to overlap the glass security pane part and thus slide leftwards and rightwards, a locking unit being provided to a side of the security pane part which contacts the casing.

Preferably, the security pane part includes an insect-screening security pane frame having a step, the step being provided on each of upper and lower portions of the insect-screening security pane frame and formed to be lower at an inside position thereof. An insect screen is provided to a first side of the insect-screening security pane frame, and an security pane is secured to a second side of the insect-screening security pane frame via a presser.

Preferably, the presser includes four parts that are upper, lower, left, and right parts, each presser part having a cross-section which has a straight-line-shaped front and is wide at an upper portion and narrow at a lower portion, the wide lower opening portion having elasticity, and locking pieces being provided on both ends of the presser, so that the presser is force-fitted into a presser insert groove which has locking steps and is formed on the glass security pane frame or the insect-screening security pane frame, an extension piece being provided on a back surface of the upper portion of the presser to support a front of the security pane.

Thanks to such a construction, the sliding window assembly may have both the insect screening function and the crime-prevention function, may be opened or closed when necessary, and realizes easy manufacture, installation, and repair, in addition to having a sturdy structure.

A height-adjusting roller is provided at at least one place on the upper or lower slide groove of the glass security pane frame of the glass security pane part.

The height-adjusting roller comprises an assembly which is constructed so that a housing is secured at a bottom thereof to the glass security pane frame, a wheel and a support block are housed in the housing, a fastening bolt for adjusting a height of the wheel passes in a direction from a rear portion to a front portion to be inserted into a bolt hole formed in a rear wall of each of the housing and the support block, and a central shaft passes through vertical guide longitudinal holes formed in both side walls of the housing, slanted guide longitudinal holes formed in both side walls of the support block, and a central hole of the wheel, thus fastening the housing, the support block, and the wheel.

Such a construction is advantageous in that the glass security pane frame is in close contact with the casing rail, thus preventing the weight of the glass security pane part from being concentrated on the insect-screening security pane part which is not inserted into the rail, even when the insect-screening security pane part rotates, therefore maintaining a balance between the glass security pane part and the insect-screening security pane part, and more firmly supporting the glass security pane part.

### Advantageous Effects

As described above, an effect of the present invention is to provide a sliding window assembly having a security pane unit, which may be opened or closed when necessary, allows persons to escape in the event of an emergency, allows packages to be removed in the event of a move, and is produced at a low cost, in addition to being easily manufactured and installed.

Another effect of the present invention is to provide a sliding window assembly having a security pane unit, which is not a foldable structure, thus making little noise when it is opened or closed, and which can have various lattice shapes, thus providing a good appearance to the window assembly.

A further effect of the present invention is to provide a sliding window assembly having a security pane unit, which requires a lower number of casing rails, thus minimizing the space for installing the window assembly, and reducing manufacturing and installing costs, in addition to affording easy manufacture, installation, and repair.

Yet another effect of the present invention is to provide a sliding window assembly having a security pane unit, which is more stably opened or closed, and allows the security pane unit to be firmly installed, thus enhancing a crime prevention effect.

### BRIEF DESCRIPTION OF THE DRAWINGS

FIG. 1 is a perspective view showing a conventional sliding-type security pane unit;

FIG. 2 is a perspective view showing a sliding window assembly having a security pane unit, according to the first embodiment of the present invention, in which the sliding window assembly is closed;

FIGS. 3 and 4 are views showing the state where the security pane unit of FIG. 2 is opened and moved;

FIG. 5 is a cross-sectional view taken along line A-A of FIG. 2;

FIG. 6 is a cross-sectional view of a sliding window assembly having a security pane unit, according to a modification of the present invention;

FIGS. 7 and 8 are vertical sectional views of the sliding window assembly having the security pane unit, according to the modification of the present invention;

FIG. 9 is a front view of a sliding window assembly having a security pane unit, according to another modification of the present invention;

FIG. 10 is a perspective view of a sliding window assembly having a security pane unit, according to the second embodiment of the present invention;

FIG. 11 is an exploded perspective view of the sliding window assembly having the security pane unit, according to the second embodiment of the present invention;

FIG. 12 is a cross-sectional view taken along line B-B of FIG. 10;

FIG. 13 is a vertical sectional view taken along line C-C of FIG. 10;

FIG. 14 is a perspective view showing part of the sliding window assembly having the security pane unit, according to the second embodiment of the present invention;

FIG. 15 is a vertical sectional view taken along line D-D of FIG. 14;

FIG. 16 is an exploded perspective view showing part of the sliding window assembly having the security pane unit, according to the second embodiment of the present invention; and

FIG. 17 is an exploded perspective view of a height adjusting roller included in the sliding window assembly having the security pane unit, according to the present invention.

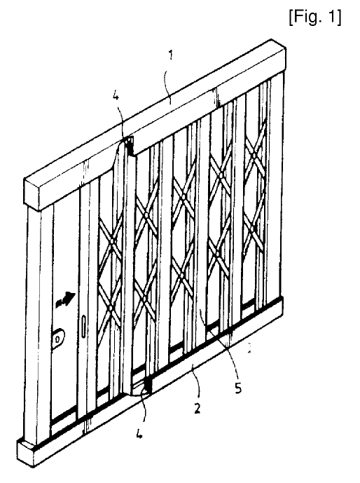

### BEST MODE FOR CARRYING OUT THE INVENTION

Hereinafter, the preferred embodiments of the present invention will be described in detail with reference to the accompanying drawings.

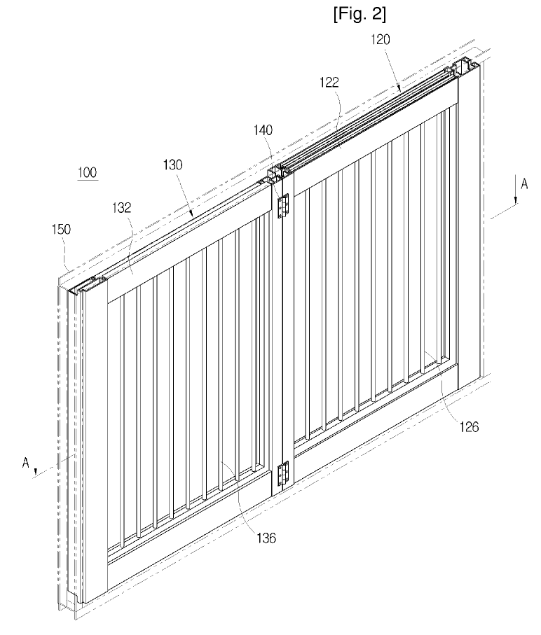

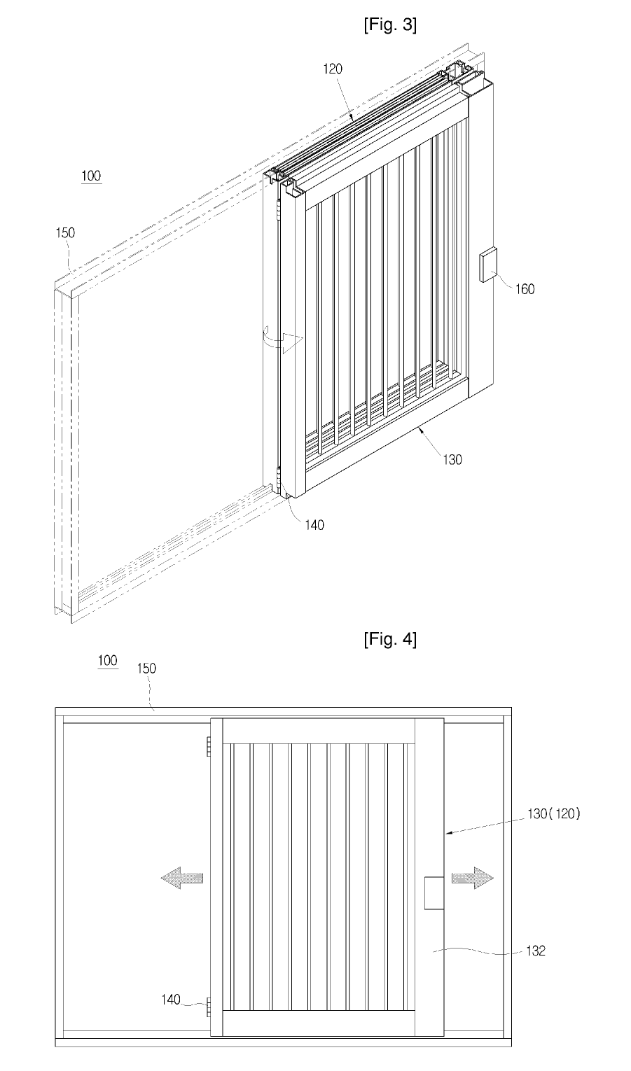

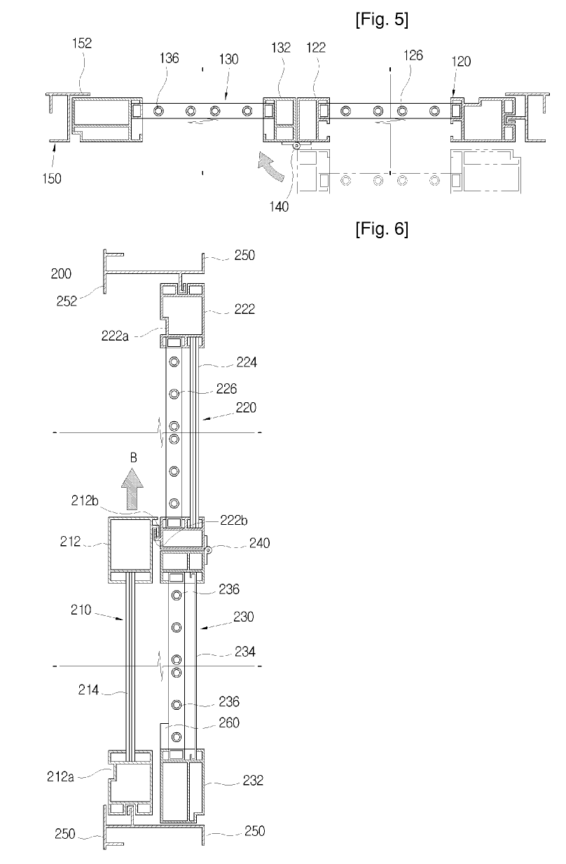

FIG. 2 is a perspective view showing a sliding window assembly having a security pane unit, according to the first embodiment of the present invention, in which the sliding window assembly is closed, and FIGS. 3 and 4 are views showing the state where the security pane unit of FIG. 2 is opened and moved. Further, FIG. 5 is a cross-sectional view taken along line A-A of FIG. 2.

As shown in the drawings, a sliding window assembly 100 having a security pane unit, according to the present invention, includes a casing 150, a first security pane part 120, and a second security pane part 130. The casing 150 is provided with two or more rails, and is open at the front thereof to the outside. The first security pane part 120 is provided with lattice strips 126, with slide grooves being formed on the upper and lower portions of the first security pane part 120 such that the first security pane part 120 slides along an outer rail of the casing 150. The second security pane part 130 is provided with lattice strips 136, and is rotatably hinged via rotary members 140 to the same rail as the first security pane part 120 at the central position of the casing 150. Thereby, the second security pane part 130 rotates about the rotary members 140 to overlap the first security pane part 120. In such a state, the first and second security pane parts 120, 130 are movable leftwards and rightwards.

Each of the first and second security pane parts 120 and 130 may be manufactured by installing various shapes of lattice strips 126, 136 made of steel, stainless steel, aluminum, etc. within a frame 122, 132. Further, if necessary, an item, such as an insect screen, may be detachably provided on at least one of the first and second security pane parts 120 and 130.

Each of the upper and lower portions of the frame 132 of the second security pane part 130 is provided with a step which has an inverted ‘L’ shaped- or [symbol] -shaped cross section and is lower at an inside portion thereof (see reference numeral 232 of FIG. 8). Thus, such a structure allows the second security pane part to be opened or closed, while preventing interference between the frame 132 of the second security pane part and the outer rail of the casing 150.

The rotary members 140 are not limited to special members. As long as the members can rotate through 180 degrees, anything may be used as the rotary members 140. For example, hinges or the like may be used as the rotary members 140.

The front of the casing 150 of the security pane unit according to the present invention is open, unlike the rear of the casing 150. That is, the front of the casing 150 does not have a rail or a flange 152 shown in FIG. 5. That is, when the second security pane part 130 is rotated outwards, there is no structure hindering the rotation, so that the second security pane part 130 may overlap the first security pane part 120.

Meanwhile, when the first security pane part 120 overlaps the second security pane part 130, the sliding window assembly may further include a support means for supporting the overlapping state. This is advantageous in that it prevents the first and second security pane parts 120 and 130 from becoming separated from each other when the first and second security pane parts 120 and 130 move leftwards or rightwards while overlapping each other. For example, the support means comprises a magnet provided on one side of each of the security pane parts 120 and 130, thus supporting the security pane parts 120 and 130 when they overlap each other. Such a construction has a support effect, in addition to preventing the appearance of the window from being marred.

The sliding window assembly 100 having the security pane unit, according to the present invention, is provided with locking units 160. The locking unit 160 is provided on one side of each of the first and second security pane parts contacting the casing 150, and locks each of the first and second security pane parts 120 and 130 to the casing 150, when the first and second security pane parts 120 and 130 are closed, as shown in FIG. 2.

According to this embodiment constructed as described above, the sliding window assembly may be opened or closed as necessary, thus allowing a person to escape in the event of an emergency, and permitting the removal of furniture in the event of a move. Further, the invention is advantageous in that it realizes easier manufacture and installation, and the manufacturing cost is inexpensive compared to a conventional security window.

Moreover, since the sliding window assembly of this invention is not foldable, little noise is made when the window assembly is opened or closed. The shape of a lattice may be variously changed, thus improving the appearance of the window. Further, the first and second security pane parts 120 and 130 move while overlapping each other, thus preventing the security pane unit from protruding outside to thereby cause problems when the security pane unit is opened. The embodiment is applicable to the case where one desires to additionally install the security pane unit to a window having glass and/or an insect screen.

Hereinafter, the operation of the sliding window assembly having the security pane unit according to this embodiment will be described with reference to FIGS. 2 to 5.

When crime prevention is required while a person is absent or asleep, as shown in FIG. 2, the first and second security pane parts 120 and 130 are closed and locked to the casing 150 using the locking units (see reference numeral 160 of FIG. 3).

Meanwhile, when a person desires to open the sliding window assembly 100 having the security pane unit, as necessary, for example, in the event of an emergency or a move, each locking unit is unlocked. Next, as shown in FIGS. 3 and 4, the second security pane part 130 is rotated outwards about the rotary members 140, so that the second security pane part 130 is superposed on the front of the first security pane part 120. As described above, the front of the casing 150 is opened so as to rotate the second security pane part 130.

As such, while the first and second security pane parts 120 and 130 overlap each other, the first security pane part 120 moves along the rail of the casing 150 and therefore opens to a desired side. At this time, the second security pane part 130 overlapping the first security pane part 120 moves along with the first security pane part 120. Further, the support means, such as a magnet, is provided in each of the first and second security pane parts 120 and 130, thus preventing the first and second security pane parts 120 and 130 from becoming separated from each other.

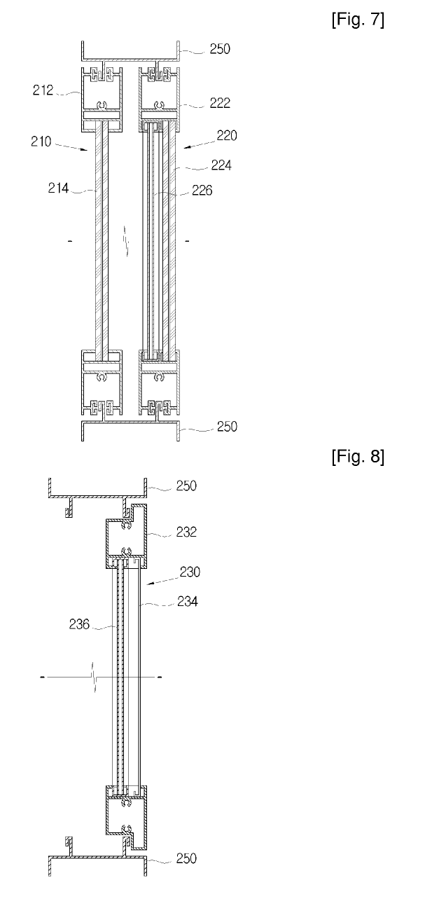

FIG. 6 is a cross-sectional view of a sliding window assembly having a security pane unit, according to a modification of the present invention, and FIGS. 7 and 8 are vertical sectional views of the sliding window assembly having the security pane unit, according to the modification of the present invention.

According to this embodiment, a sliding window assembly 200 having a security pane unit is further provided with an inner pane part 210 inside a second security pane part 230. The inner pane part 210 is manufactured by fitting glass 214 in a frame 212. A first security pane part 220 further includes glass 224 fitted within a frame 222. Further, an insect screen 234 is additionally provided on one side of the second security pane part 230.

According to the known art, the inner pane part 210 is installed to be hooked to the first security pane part 220 using locking steps 212b and 222b (referred to as hooks). That is, referring to FIG. 6, the inner pane part 210 and the first security pane part 220 are coupled to each other by the inward-bent locking step 212b provided at a predetermined position on the frame 212 of the inner pane part 210, which is adjacent to the frame 222 of the first security pane part 220, and the locking step 222b, which is provided at a position on the frame 222 of the first security pane part 220 to engage with the locking step 212b.

Referring to the drawings, lattice strips 226 are installed in the first security pane part 220, and the glass 224 is installed outside the lattice strips 226. However, the positions of the lattice strips and the glass may be changed as necessary. Further, if necessary, the positions of lattice strips 236 and the insect screen 234 installed on the second security pane part 230 may be changed.

If the sliding window assembly having the security pane unit constructed as described above is installed, it is not necessary to install a separate glass window or a security window for a veranda, unlike the prior art. Thus, it can advantageously reduce the cost of manufacturing and installing the window. Reference numerals 212a and 222a denote handle recesses. Meanwhile, since the operation of this embodiment remains the same as the first embodiment, it will not be described in detail below.

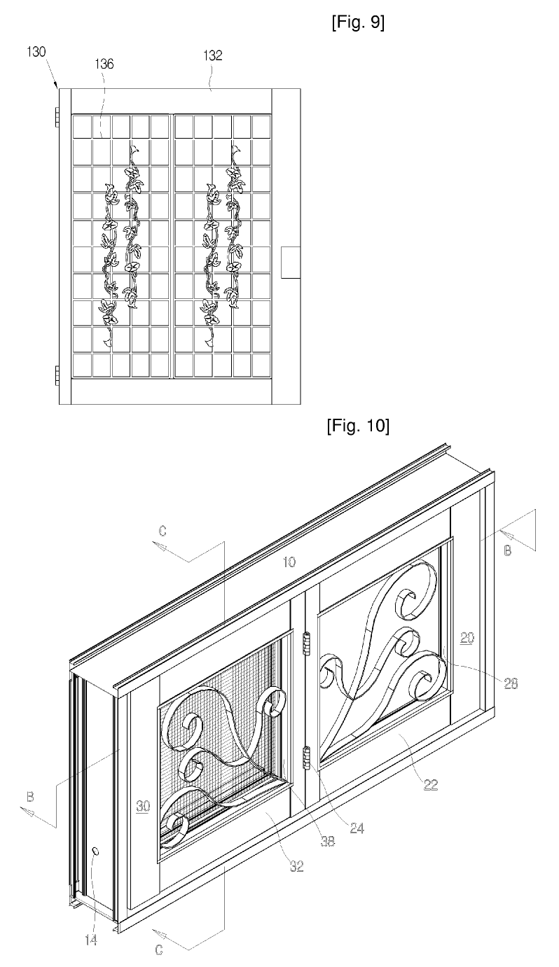

FIG. 9 is a front view of a sliding window assembly having a security pane unit, according to another modification of the present invention. Those elements common to both FIG. 9 and FIG. 2 will carry the same reference numerals. As shown in the drawing, the sliding window assembly having the security pane unit according to this invention may have a variously shaped lattice strips 136, thus improving the appearance of the window.

The above embodiments are applied to the case where the number of pane parts is two in a width direction. However, the present invention may be applied to the case where the number of pane parts is more than two in a width direction.

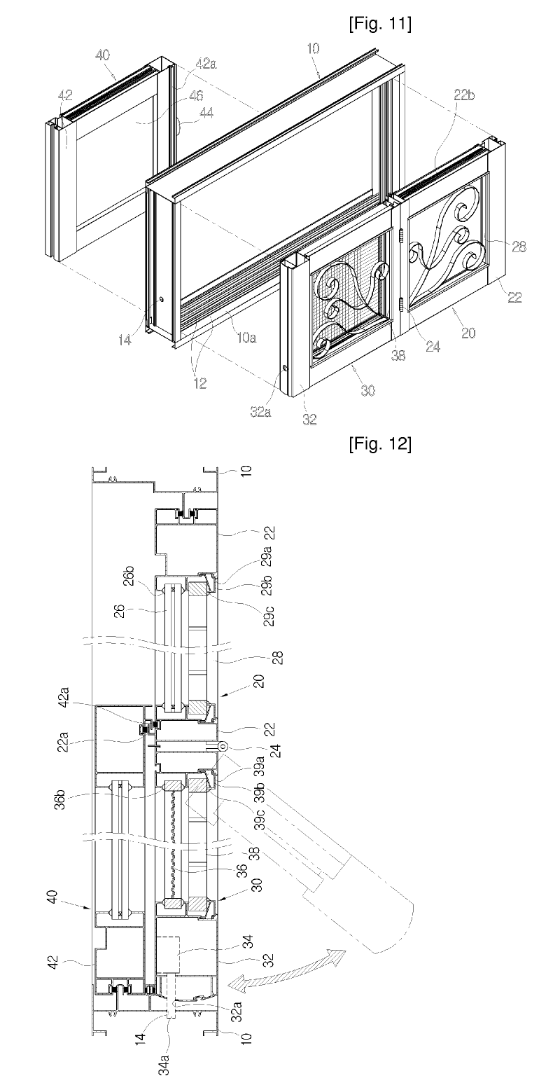

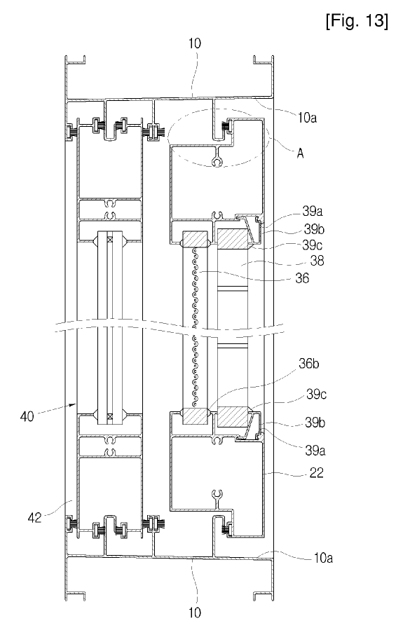

FIG. 10 is a perspective view of a sliding window assembly having a security pane unit, according to the second embodiment of the present invention, and FIG. 11 is an exploded perspective view of the sliding window assembly having the security pane unit, according to the second embodiment of the present invention. FIG. 12 is a cross-sectional view taken along line B-B of FIG. 10, and FIG. 13 is a vertical sectional view taken along line C-C of FIG. 10.

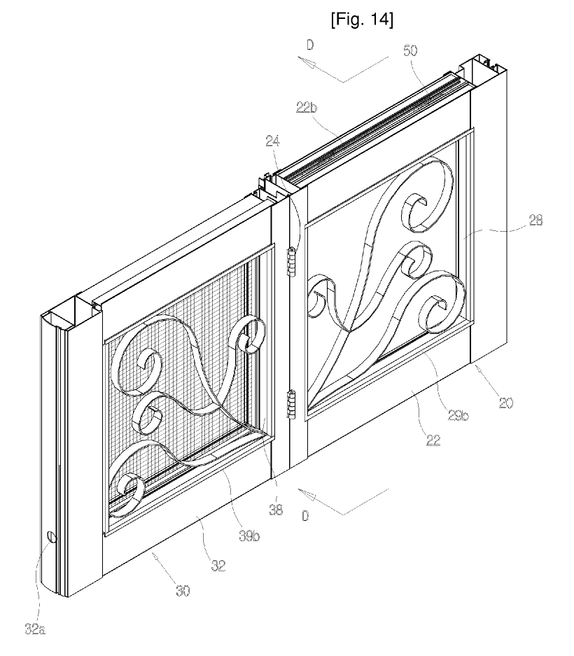

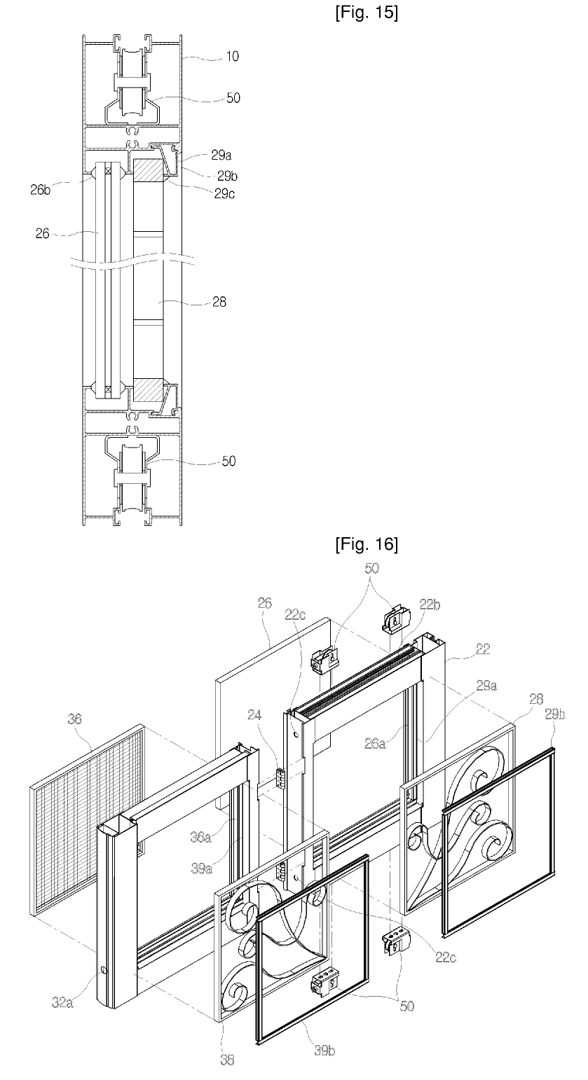

FIG. 14 is a perspective view showing part of the sliding window assembly having the security pane unit, according to the second embodiment of the present invention, and FIG. 15 is a vertical sectional view taken along line D-D of FIG. 14.

Referring to the drawings, a sliding window assembly having a security pane unit, according to the invention, includes a casing 10, a glass security pane part 20, and an insect-screening security pane part 30. The casing 10 is provided with two or more rails 12, and is open at a front thereof. The glass security pane part 20 is provided with a glass security pane frame 22 having a slide groove 22b such that the glass security pane part slides along an outer rail 12 of the casing 10. The insect-screening security pane part 30 is installed on the same rail as the glass security pane part 20 via rotary members, and rotates about the rotary members to overlap the glass security pane part 20. When the insect-screening security pane part 30 overlaps the glass security pane part 20, they may slide in a horizontal direction.

In the sliding window assembly having the security pane unit according to the present invention, the front of the casing 10 is open, unlike the rear of the casing 10. That is, referring to FIG. 11, the outermost end 10a of the casing 10 does not have a rail or a flange. A construction having such a structure does not hinder the outward rotation of the insect-screening security pane part 30 about the rotary members, thus allowing the insect-screening security pane part 30 to overlap the glass security pane part 20 (see FIG. 12).

Further, glass 26 is provided within the glass security pane frame 22, and a security pane 28 is installed outside the glass 26 using a presser 29b. If necessary, the positions of the glass 26 and the security pane 28 may be changed. When a sliding window assembly, having the glass 26 at an inner position and the security pane 28 at an outer position, is installed at a site, the sliding window assembly having only the glass 26, installed in a glass manufacturing factory, is carried to the site and then installed, thus affording convenience.

As in a general glass window, the glass 26 is inserted into a glass insert groove 26a of the glass security pane frame 22. Thereafter, the glass 26 is sealed and secured with a silicone caulking 26b. Next, after the security pane 28 is placed at a predetermined position, an end of the presser 29b having elasticity is force-fitted into a presser insert groove 29a formed on the glass security pane frame 22. Thereafter, the portion where the security pane 28 contacts the presser 29b is sealed and secured with silicone caulking 29c.

Referring to FIG. 12, the presser 29b includes four parts, that is, upper, lower, left, and right parts. Each presser part has a cross section wherein the front thereof when viewed from the casing is linear, the upper portion thereof is narrow, and the lower portion thereof is wide. In this case, a wide lower opening portion has elasticity, and locking pieces are provided on both ends of the presser. Thereby, the presser is force-fitted into the presser insert groove 29a which has locking steps and is formed on the glass security pane frame 22. Further, an extension piece is provided on the back of the upper portion of the presser to support the front of the security pane 28.

A locking unit 34 is provided to a side of an insect-screening security pane frame 32 of the insect-screening security pane part 30 contacting the casing 10, thus functioning to lock the insect-screening security pane part 30. The locking unit 34 may use known locking units, without being limited to a special locking unit. For example, a key lock may be used as the locking unit of this invention. In this case, the casing 10 and the insect-screening security pane frame 32 have locking holes 14 and 32a such that a locking protrusion 34a of the key lock passes through the casing 10 and the insect-screening security pane frame 32.

An insect screen 36 is provided at an inner position of the insect-screening security pane frame 32, and a security pane 38 is secured to an outer position of the insect-screening security pane frame 32 using a presser 39b. If necessary, the positions of the insect screen 36 and the security pane 38 may be changed.

After the insect screen 36 is inserted into an insect-net insert groove 36a formed on the insect-screening security pane frame 32, the insect screen 36 is sealed and secured with silicone caulking 36b. Next, after the security pane 38 is placed at a predetermined position, an end of the elastic presser 39b is force-fitted into a presser insert groove 39a formed on the insect-screening security pane frame 32. Next, the portion where the security pane 38 contacts the presser 39b is sealed and secured with silicone caulking 39b. Since the shape and function of the presser 39b installed in the insect-screening security pane frame 32 are the same as those of the presser 29b installed in the glass security pane frame 22, they will not be described in detail below.

Referring to FIG. 13, the insect-screening security pane frame 32 is provided with upper and lower steps which have an inverted ‘L’ shaped- or [symbol] -shaped cross section and are lower at an inside portion thereof (see reference character ‘A’ of FIG. 13). Thus, such a structure prevents interference between the insect-screening security pane frame 32 and the outer rail 12 of the casing 10, and allows the insect-screening security pane part to move forwards and thus be opened or closed.

The rotary members installed between the glass security pane part 20 and the insect-screening security pane part 30 are not limited to particular structures, as long as they can rotate at 180 degrees. For example, as shown in FIG. 10, one or more hinges 24 may be used as the rotary members. The wings of each hinge 24 are secured to the sides of the glass security pane frame 22 and the insect-screening security pane frame 32.

Referring to FIG. 11, the sliding window assembly may further include one or more inner glass pane parts 40 which are installed to slide along the inner rail 12 of the casing 10. That is, it is possible to provide only one inner glass pane part 40. Alternatively, a pair of inner glass pane parts 40 may be installed to have the structure of a double window which has a crime-prevention function and an insect screening function.

Referring to FIG. 12, a locking step 42a, which is inwardly bent, is provided at a predetermined position on an inner glass pane frame 42 having glass 46. The locking step 42a is fastened to a locking piece 22a which is provided on the glass security pane frame 22 to correspond to the locking step, so that the inner glass pane part 40 and the glass security pane part 20 are locked to each other, in addition to enhancing air-tightness. Moreover, the inner glass pane part 40 and the glass security pane part 20 may be more firmly secured to each other using a crescent lock (see reference numeral 44 of FIG. 11).

A height-adjusting roller 50 is provided at one or more places on upper and lower slide grooves 22b of the glass security pane frame 22 of the glass security pane part 20. Referring to FIG. 17, the height-adjusting roller 50 includes a housing 51 which is secured at a bottom thereof to the glass security pane frame 22. A wheel 52 and a support block 53 are installed in the housing 51. A fastening bolt 54 for adjusting the height of the wheel is inserted in a direction from a rear position to a front position to pass through respective bolt holes 51a and 53a formed on rear walls of the housing 51 and the support block 53, such that the end of the fastening bolt 54 is fastened to the bolt hole 53a of the support block.

Vertical guide longitudinal holes 51b are formed in opposite side walls of the housing 51, and slanted guide longitudinal holes 53b are formed in opposite side walls of the support block 53. Further, a central shaft 56 passes through the vertical guide longitudinal holes 51b of the housing 51, the slanted guide longitudinal holes 53b of the support block 53, and central holes 52a of the wheel 52, thus securing the components to each other.

When the fastening bolt 54 is turned in one direction, the housing 51, secured at the bottom thereof to the glass security pane frame 22, approaches the support block 53. At this time, the central shaft 56 moves along the slanted guide longitudinal holes 53b, so that the wheel 52 through which the central shaft 56 passes moves toward the casing 10.

Such a construction allows the glass security pane frame 22 to be in firm contact with the rail 12 of the casing 10, thus maintaining balance between the glass security pane part 20 and the insect-screening security pane part 30, which is not inserted into the rail 12. Further, the construction more firmly supports the glass security pane part 20, thus allowing the insect-screening security pane part 30 to stably rotate while preventing the glass security pane part 20 from shaking due to the weight of the insect-screening security pane part 30 when the insect-screening security pane part 30 rotates.

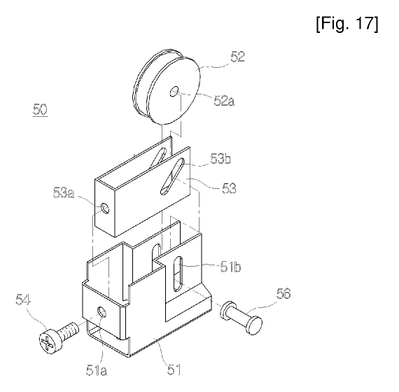

FIG. 16 is an exploded perspective view showing part of the sliding window assembly having the security pane unit, according to the second embodiment of this invention. The method of manufacturing, assembling, and installing the sliding window assembly having the security pane unit according to this invention will be described with reference to FIG. 16.

First, the glass security pane frame 22 and the insect-screening security pane frame 32 are connected to each other using the hinges 24. Next, the glass 26 is inserted into the glass insert groove 26a formed on the glass security pane frame 22 having the height-adjusting rollers 50 which are installed at two places on each of the upper and lower slide grooves 22b. The glass 26 is secured to the glass security pane frame by sealing with the silicone caulking (see reference numeral 26b of FIG. 12) at front and rear surfaces. Further, in the same manner as the glass security pane part, the insect screen 36 is inserted into the insect-net insert groove 36a formed on the insect-screening security pane frame 32, and is secured to the insect-screening security pane frame by sealing with the silicone caulking (see reference numeral 36b of FIG. 12) at front and rear surfaces.

Subsequently, after the security pane 28 of the glass security pane part 20 is placed at a predetermined position, the end of the elastic presser 29b is force-fitted into the presser insert groove 29a formed on the glass security pane frame 22, thus securing the security pane 28. In order to more reliably secure the security pane and prevent the entry of moisture, the portion where the security pane 28 contacts the presser 29b is sealed with silicone caulking (see reference numeral 29c of FIG. 12) at the front surface. Further, in the same manner, the security pane 38 of the insect-screening security pane part 30 is placed in a predetermined position. Next, the end of the elastic presser 39b is force-fitted into the presser insert groove 39a formed on the insect-screening security pane frame 32, thus securing the security pane 38. The portion where the security pane 38 contacts the presser 39b is sealed with silicone caulking (see reference numeral 39c of FIG. 12) at the front surface.

As such, when the security pane 28, 38 is secured using the presser 29b, 39b, it is easy to manufacture and install a combination window of the glass pane part and the security pane part or a combination window of the insect screen and the security pane part. Further, when one or more of the glass 26, the insect screen 36, and the security panes 28 and 38 is damaged and is thus required to be repaired, the caulking 29c and 39c provided between the security pane 28, 38 and the presser 29b, 39b is cut with a knife, and thereafter, the presser 29b, 39b may be removed using a simple tool. Further, after the repair has been completed, it is easy to re-assemble the parts in reverse order.

Moreover, when the sliding window assembly having the security pane unit according to this invention is installed in a veranda window, it solves the difficulty of construction due to the installation of an additional security pane unit. Further, the number of rails required is reduced, thus minimizing space for installing the sliding window assembly, in addition to reducing production and installation costs.

Next, referring to FIG. 11, the prefabricated sliding window assembly is mounted to the casing 10 having the inner glass pane part 40. In this case, the locking step 42a provided to one side of the inner glass pane frame 42 of the inner glass pane part 40 is fastened to the locking piece 22a of the glass security pane frame 22, so that the inner glass pane part 40 is secured to the glass security pane part 20.

Further, a screwdriver is inserted into each of height-adjusting holes 22c formed in both side surfaces of the glass security pane frame 22, thus adjusting the bolt 54 of each height-adjusting roller 50 installed in the glass security pane frame 22, therefore forcing the glass security pane frame 22 into close contact with the rail 12 of the casing 10. Such a construction is advantageous in that balance is maintained between the insect-screening security pane part 30 which is not inserted into the rail 12 of the casing 10 and the glass security pane part 20, and the insect-screening security pane part 30 is more firmly supported. Particularly, when the heavy insect-screening security pane part 30 rotates about the hinges 24, the glass security pane part 20 is safely supported. Further, the rollers 50 allow the glass security pane part 20 to stably move along the rail 12 to be thus opened or closed.

Hereinafter, the operation of the sliding window assembly having the security pane unit according to the present invention installed as described above will be described with reference to FIG. 12.

When crime prevention is required while a person is absent or asleep, both of the glass security pane part 20 fastened to the inner glass pane part 40 and the insect-screening security pane part 30 are closed. In such a state, they may be locked to the casing 10 using the locking protrusion 34a of the locking unit 34. When insect-screening and crime-prevention functions are required, only the inner glass pane part 40 is opened.

Meanwhile, if necessary, for example, in an emergency escape or when moving, the locking unit 34 of the insect-screening security pane part 30 is unlocked, and the insect-screening security pane part 30 is rotated outwards about the hinges 24, thus overlapping the front of the glass security pane part 20. In such a state, the glass security pane part 20 moves along the rail (see reference numeral 12 of FIG. 11) of the casing 10, so that the sliding window assembly may be opened in a desired direction. Moreover, the support means, such as a magnet, is provided in each of the glass security pane part 20 and the insect-screening security pane part 30, thus preventing the glass security pane part 20 and the insect-screening security pane part 30 from becoming separated from each other.

When the sliding window assembly according to this invention constructed as described above is applied to an apartment which is newly built, it is not necessary to separately install a glass window and a security window, and space for installing a window can be minimized, thus reducing the cost of manufacturing and installing the window.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sliding window assembly having a security pane unit, comprising: a casing having two or more rails, and being open at a front thereof to an outside; a first security pane part having lattice strips, slide grooves being formed on upper and lower portions of the first security pane part such that the first security pane part slides along an outer rail of the casing; and a second security pane part having lattice strips, and mounted to the same rail as the first security pane part at a central position of the casing in such a way as to be rotated via a rotary member, the secondary security pane part rotating about the rotary member to overlap the first security pane part and thus move leftwards and rightwards.

2. The sliding window assembly according to claim 1, wherein the second security pane part comprises a frame having a step, the step being provided on each of upper and lower portions of the second security pane part frame, and formed to be lower at an inside position thereof.

3. The sliding window assembly according to claim 1, wherein glass is further provided on one side of the first security pane part, and an inner pane part having glass is provided inside the second security pane part.

4. The sliding window assembly according to claim 1, wherein an insect screen is further installed on one side of the frame of the second security pane part.

5. The sliding window assembly according to claim 1, further comprising: support means to maintain the first and second security pane parts in an overlapping state.

6. A sliding window assembly having a security pane unit, comprising: a casing having two or more rails, and being open at a front thereof to an outside; a glass security pane part, comprising: a glass security pane frame having at each of upper and lower portions thereof a slide groove such that the glass security pane part slides along an outer rail of the casing, glass being provided to a first side of the glass security pane frame, and a security pane being secured to a second side of the glass security pane frame via a presser; and a security pane part mounted to the same rail as the glass security pane part via a rotary member, and rotating about the rotary member to overlap the glass security pane part and thus slide leftwards and rightwards, a locking unit being provided to a side of the security pane part which contacts the casing.

7. The sliding window assembly according to claim 6, wherein the security pane part comprises an insect-screening security pane frame having a step, the step being provided on each of upper and lower portions of the insect-screening security pane frame and formed to be lower at an inside position thereof.

8. The sliding window assembly according to claim 7, wherein an insect screen is provided to a first side of the insect-screening security pane frame, and an security pane is secured to a second side of the insect-screening security pane frame via a presser.

9. The sliding window assembly according to claim 6, wherein the presser comprises four parts that are upper, lower, left, and right parts, each presser part having a cross-section which has a straight-line-shaped front and is wide at an upper portion and narrow at a lower portion, the wide lower opening portion having elasticity, and locking pieces being provided on both ends of the presser, so that the presser is force-fitted into a presser insert groove which has locking steps and is formed on the glass security pane frame or the insect-screening security pane frame, an extension piece being provided on a back surface of the upper portion of the presser to support a front of the security pane.

10. The sliding window assembly according to claim 6, wherein a height-adjusting roller is provided at at least one place on the upper or lower slide groove of the glass security pane frame of the glass security pane part.

11. The sliding window assembly according to claim 10, wherein the height-adjusting roller comprises an assembly which is constructed so that a housing is secured at a bottom thereof to the glass security pane frame, a wheel and a support block are housed in the housing, a fastening bolt for adjusting a height of the wheel passes in a direction from a rear portion to a front portion to be inserted into a bolt hole formed in a rear wall of each of the housing and the support block, and a central shaft passes through vertical guide longitudinal holes formed in both side walls of the housing, slanted guide longitudinal holes formed in both side walls of the support block, and a central hole of the wheel, thus fastening the housing, the support block, and the wheel.

12. The sliding window assembly according to claim 6, further comprising: one or more inner glass pane parts installed to slide along an inner rail of the casing.

13. The sliding window assembly according to claim 2, wherein glass is further provided on one side of the first security pane part, and an inner pane part having glass is provided inside the second security pane part.

14. The sliding window assembly according to claim 2, wherein an insect screen is further installed on one side of the frame of the second security pane part.

15. The sliding window assembly according to claim 2, further comprising: support means to maintain the first and second security pane parts in an overlapping state.

16. The sliding window assembly according to claim 7, wherein the presser comprises four parts that are upper, lower, left, and right parts, each presser part having a cross-section which has a straight-line-shaped front and is wide at an upper portion and narrow at a lower portion, the wide lower opening portion having elasticity, and locking pieces being provided on both ends of the presser, so that the presser is force-fitted into a presser insert groove which has locking steps and is formed on the glass security pane frame or the insect-screening security pane frame, an extension piece being provided on a back surface of the upper portion of the presser to support a front of the security pane.

17. The sliding window assembly according to claim 7, wherein a height-adjusting roller is provided at at least one place on the upper or lower slide groove of the glass security pane frame of the glass security pane part.

18. The sliding window assembly according to claim 7, further comprising: one or more inner glass pane parts installed to slide along an inner rail of the casing.
